(19) United States
(12) Patent Application Publication
(10) Pub. No.: US 2025/0258806 A1
(43) Pub. Date: Aug. 14, 2025

(54) ENCODING AND DECODING TRIE DATA STRUCTURES FOR ENHANCED GENERATION OF CUSTOMER JOURNEY ANALYTICS

(71) Applicant: Genesys Cloud Services, Inc., Menlo Park, CA (US)

(72) Inventors: Ankit Pat, Toronto (CA); Maud D. McEvoy, Galway (IE); Colm John Hally, Galway (IE)

(21) Appl. No.: 19/051,096

(22) Filed: Feb. 11, 2025

Related U.S. Application Data
(60) Provisional application No. 63/552,841, filed on Feb. 13, 2024.

(51) Int. Cl. G06F 16/22

(52) U.S. Cl. CPC G06F 16/2246; G06F 16/2272

(57) ABSTRACT

A method for efficiently encoding a trie data structure for transmission according to an embodiment includes receiving an application programming interface (API) request pertaining to the trie data structure that is indicative of flows of customer interactions with automated agents of a contact center, obtaining the trie data structure in which each of multiple nodes has an associated prefix key that defines a path from a root to the corresponding node, and encoding the nodes in a transmission format having a dictionary data structure. The nodes in the transmission format do not have the prefix key that defines the path from the root to the corresponding node. The method also includes transmitting a response to the API request based on the trie data structure encoded in the transmission format.

### CROSS-REFERENCE TO RELATED APPLICATIONS

This application claims priority to and the benefit of U.S. Provisional Application No. 63/552,841, titled “ENCODING AND DECODING TRIE DATA STRUCTURES FOR ENHANCED GENERATION OF CUSTOMER JOURNEY ANALYTICS,” filed on Feb. 13, 2024, the contents of which are incorporated herein by reference in their entirety.

### BACKGROUND

A customer of a product or service provided by an organization may contact a call center or contact center associated with an organization to obtain support related to the product or service. In doing so, the customer may interact with human and/or virtual agents via electronic communications through technologies including, for example, telephone, email, web chat, Short Message Service (SMS), dedicated software application(s), and/or other technologies. In many scenarios, a customer may be routed among multiple agents as the communication progresses and the type of support and/or the particular agent best suited to provide the requested support is determined.

### SUMMARY

One embodiment is directed to a unique system, components, and methods for encoding and decoding trie data structures for enhanced generation of customer journey analytics. Other embodiments are directed to apparatuses, systems, devices, hardware, methods, and combinations thereof for encoding and decoding trie data structures for enhanced generation of customer journey analytics.

According to an embodiment, a method for efficiently encoding a trie data structure for transmission may include receiving, by a computing system, an application programming interface (API) request pertaining to the trie data structure. The trie data structure may be indicative of flows of customer interactions with automated agents of a contact center. The method may further include obtaining, by the computing system, the trie data structure in which each node of multiple nodes of the trie data structure has an associated prefix key that defines a path from a root to the corresponding node. Further, the method may include encoding, by the computing system, the nodes of the trie data structure in a transmission format having a dictionary data structure, in which an identifier of each node is defined as a key of the corresponding node and a parent node identifier for each node is defined as a value of the corresponding node. The nodes in the transmission format do not have the prefix key that defines the path from the root to the corresponding node. The method may also include transmitting, by the computing system, a response to the API request based on the trie data structure encoded in the transmission format.

In some embodiments, encoding the nodes of the trie data structure in the transmission format may include stripping away an identifier of each node from the prefix key of the corresponding node and setting the parent node identifier for the corresponding node as a node identifier immediately preceding the identifier of the corresponding node in the prefix key.

In some embodiments, transmitting the response to the API request may include excluding, from the response, redundant data pertaining to flows for each node.

In some embodiments, excluding redundant data may include excluding, from the response, redundant identifier, version, and type data values for each flow associated with each node.

In some embodiments, transmitting the response to the API request comprises transmitting flow count data only for leaf nodes represented in the trie data structure.

In some embodiments, the method may additionally include receiving, by the computing system, the response to the API request pertaining to the trie data structure, reconstructing, by the computing system, the prefix keys for nodes of the trie data structure based on parent node identifier data associated with each node, and storing, by the computing system, the trie data structure in a storage format based on the reconstructed prefix keys for the nodes.

In some embodiments, reconstructing the prefix keys may include, for each node of a set of nodes represented in the response, (a) selecting, by the computing system, a node represented in the received response, (b) recursively traversing, by the computing system, a path from the selected node to a root of the trie data structure based on a parent node identifier associated with each node along the path to the root, and (c) storing, by the computing system, data indicative of the path as the prefix key for the selected node.

In some embodiments, the method may further include deriving, by the computing system, the prefix key of all ancestors of the selected node based on a distance of each ancestor from the selected node.

In some embodiments, the method may also include determining, by the computing system, whether a prefix key of a parent node of the selected node has already been reconstructed and utilizing, by computing system and in response to a determination that the prefix key of the parent node has already been reconstructed, the prefix key of the parent node as a remainder of the prefix key for the selected node.

In some embodiments, the method may also include reconstructing flow count data excluded from the response based on flow count data associated with each leaf node and storing the reconstructed flow count data in association with non-leaf nodes of the trie data structure.

According to another embodiment, a system for efficiently encoding a trie data structure for transmission may include at least one processor and at least one memory comprising a plurality of instructions stored thereon that, in response to execution by the at least one processor, causes the system to receive an application programming interface (API) request pertaining to the trie data structure. The trie data structure may be indicative of flows of customer interactions with automated agents of a contact center. The instructions may also cause the system to obtain the trie data structure in which each node of multiple nodes of the trie data structure has an associated prefix key that defines a path from a root to the corresponding node and encode the nodes of the trie data structure in a transmission format having a dictionary data structure, in which an identifier of each node is defined as a key of the corresponding node and a parent node identifier for each node is defined as a value of the corresponding node. The nodes in the transmission format do not have the prefix key that defines the path from the root to the corresponding node. The instructions may also cause the system to transmit a response to the API request based on the trie data structure encoded in the transmission format.

In some embodiments, to encode the nodes of the trie data structure in the transmission format may include to strip away an identifier of each node from the prefix key of the corresponding node and set the parent node identifier for the corresponding node as a node identifier immediately preceding the identifier of the corresponding node in the prefix key.

In some embodiments, to transmit the response to the API request may include to exclude, from the response, redundant data pertaining to flows for each node.

In some embodiments, to exclude redundant data may include to exclude, from the response, redundant identifier, version, and type data values for each flow associated with each node.

In some embodiments, to transmit the response to the API request comprises to transmit flow count data only for leaf nodes represented in the trie data structure.

In some embodiments, the instructions may also cause the system to receive the response to the API request pertaining to the trie data structure, reconstruct the prefix keys for nodes of the trie data structure based on parent node identifier data associated with each node, and store the trie data structure in a storage format based on the reconstructed prefix keys for the nodes.

In some embodiments, to reconstruct the prefix keys may include, for each node of a set of nodes represented in the response, to (a) select a node represented in the received response, (b) recursively traverse a path from the selected node to a root of the trie data structure based on a parent node identifier associated with each node along the path to the root, and (c) store data indicative of the path as the prefix key for the selected node.

In some embodiments, the plurality of instructions may further cause the system to derive the prefix key of all ancestors of the selected node based on a distance of each ancestor from the selected node.

In some embodiments, the plurality of instructions may further cause the system to determine whether a prefix key of a parent node of the selected node has already been reconstructed and utilize, in response to a determination that the prefix key of the parent node has already been reconstructed, the prefix key of the parent node as a remainder of the prefix key for the selected node.

According to yet another embodiment, one or more non-transitory machine-readable storage media may include a plurality of instructions stored thereon that, in response to execution by a computing system, causes the computing system to receive an application programming interface (API) request pertaining to the trie data structure. The trie data structure may be indicative of flows of customer interactions with automated agents of a contact center. The instructions may also cause the system to obtain the trie data structure in which each node of multiple nodes of the trie data structure has an associated prefix key that defines a path from a root to the corresponding node and encode the nodes of the trie data structure in a transmission format having a dictionary data structure, in which an identifier of each node is defined as a key of the corresponding node and a parent node identifier for each node is defined as a value of the corresponding node. The nodes in the transmission format do not have the prefix key that defines the path from the root to the corresponding node. The instructions may also cause the system to transmit a response to the API request based on the trie data structure encoded in the transmission format.

In some embodiments, to encode the nodes of the trie data structure in the transmission format may include to strip away an identifier of each node from the prefix key of the corresponding node and set the parent node identifier for the corresponding node as a node identifier immediately preceding the identifier of the corresponding node in the prefix key.

This summary is not intended to identify key or essential features of the claimed subject matter, nor is it intended to be used as an aid in limiting the scope of the claimed subject matter. Further embodiments, forms, features, and aspects of the present application shall become apparent from the descriptions and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIG. 3 is a simplified flow diagram of at least one embodiment of a method for filtering a trie data structure by a specific event;

FIG. 4 is a simplified flow diagram of at least one embodiment a method for filtering a trie data structure by an event attribute;

FIG. 5 is a simplified flow diagram of at least one embodiment of a method for filtering a trie data structure by a bot flow;

FIGS. 6-7 illustrate various states of an example trie data structure being filtered by a specific event;

FIGS. 8-10 illustrate various states of an example trie data structure being filtered by an event attribute;

FIGS. 11-12 illustrate various states of an example trie data structure being filtered by a bot flow;

FIG. 13 illustrates a code snippet indicative of a storage format for a trie data structure;

FIG. 14 illustrates an embodiment of a trie data structure having six types of nodes that may be utilized to represent bot flows;

FIGS. 15-18 illustrate an API response indicative of a trie data structure associated with bot flows;

FIGS. 19-20 are a simplified flow diagram of a method for encoding a trie data structure for efficient transmission;

FIG. 21 illustrates an API response that includes an identifier, a version, a type, and a count regarding a flow at a node of a trie data structure;

FIGS. 22-23 are a simplified flow diagram of a method for decoding a trie data structure from a transmission format;

FIG. 24 is a simplified flow diagram of a method for reconstructing flow data from a trie data structure in a transmission format in which flow data is only provided for leaf nodes; and

FIG. 25 illustrates example pseudocode for the method of FIG. 24.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The technologies described herein pertain to customer relations services and customer relations management via contact centers and associated cloud-based systems. More particularly, the technologies described herein enable the generation of user-friendly visualizations that assist customer-experience managers of contact centers to improve the “big picture” experience of customers in their interactions with agents associated with the contact center, including automated agents (“bots”). The visualizations may include, for example, flow milestones and outcomes of interactions. In enabling the generation of visualizations, the illustrative technologies may utilize a trie data structure while providing functionality for filtering, searching, and querying to show events in customers' journeys starting at a particular event, events that include a particular attribute value, and/or events associated with a particular bot flow (e.g., executed by a bot or automated agent of the contact center system).

Trie data structure implementations traditionally have drawbacks that limit their capabilities in certain use cases. For example, to enable filtering and querying capabilities based on any event and visualizing paths to/from that event, it is possible to simply create multiple trie data structures, with one trie data structure for each event or node within the trie data structure. However, such an approach is computationally intensive and leads to significant scalability issues. Accordingly, the technologies described herein provide for a scalable solution that permits such types of filtering and querying using trie data structures (i.e., without building separate tries for each query event). Further, the technologies described herein allow for an online (e.g., cloud-based) computational approach while maintaining reasonable latency (e.g., latency that satisfies typical service level agreement requirements, such as maximum query responses of one second). Instead of creating a trie for each filtering criterion, a single “big picture” trie may be stored for each organization, which includes each of the bot flows and associated event attributes. This approach significantly reduces the processing and read/write operations required, resulting in improved efficiency. The reduced number of files and their corresponding read/write operations also result in lower operational cost. The system can also seamlessly integrate with various bot flows, allowing for diverse and customizable functionalities.

Furthermore, and as described in more detail herein, the technologies provided herein enable efficient encoding and decoding of trie data structure information to reduce the size of application programming interface (API)-related messages transmitted between components. That is, the technologies described herein reduce the amount of data that would otherwise be transmitted in response to a request for information about a trie data structure while still providing sufficient data to enable recreation of the trie data structure based on the response. As such, a system implementing the technologies provided herein may make more efficient use of available communication capacity (e.g., network bandwidth) when responding to API requests and make that capacity available for other operations of the system.

It should be appreciated that a “trie data structure” may be simplified referred to herein as a “trie” for simplicity and brevity of the description. Further, although the technologies are described herein in reference to “bot flows,” it should be appreciated that similar technologies may be applied to other types of flows or client journeys in other embodiments.

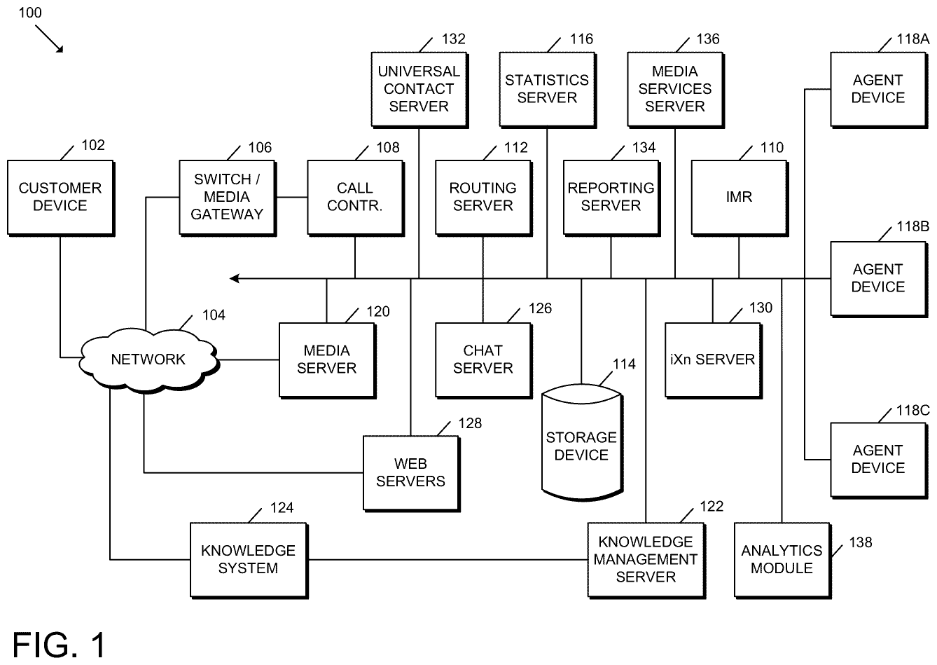

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to a customer and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots,” and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”-or, simply, the “cloud”-is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

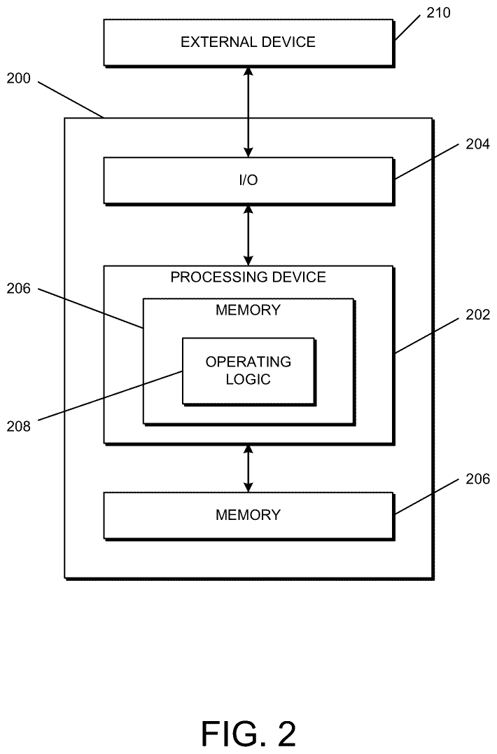

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VOIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

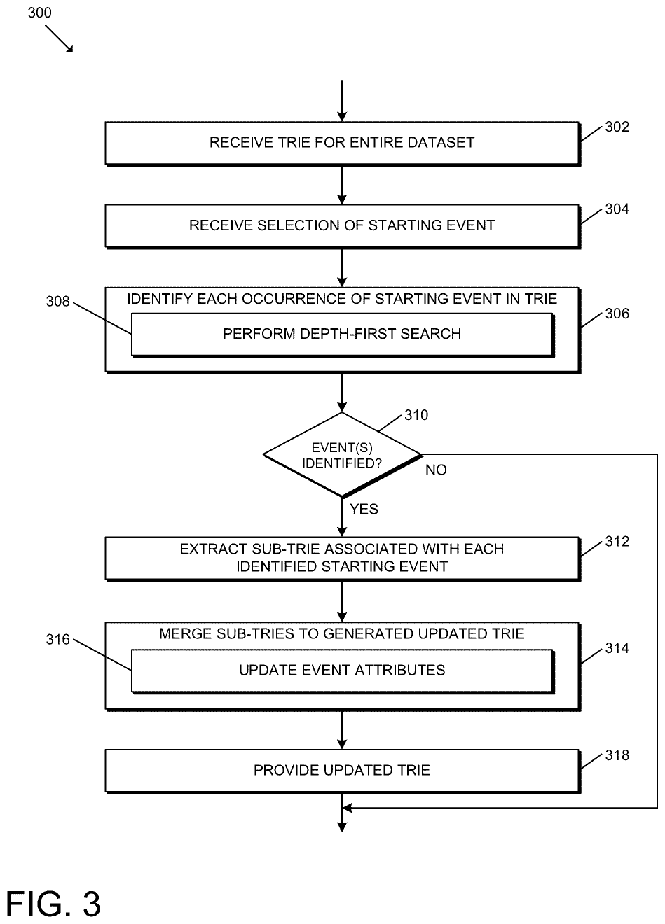

Referring now to FIG. 3, in use, a computing system (e.g., the contact center system 100, one or more computing devices 200, and/or other computing devices described herein) may execute a method 300 for filtering a trie data structure by a specific event. It should be appreciated that the particular blocks of the method 300 are illustrated by way of example, and such blocks may be combined or divided, added or removed, and/or reordered in whole or in part depending on the particular embodiment, unless stated to the contrary.

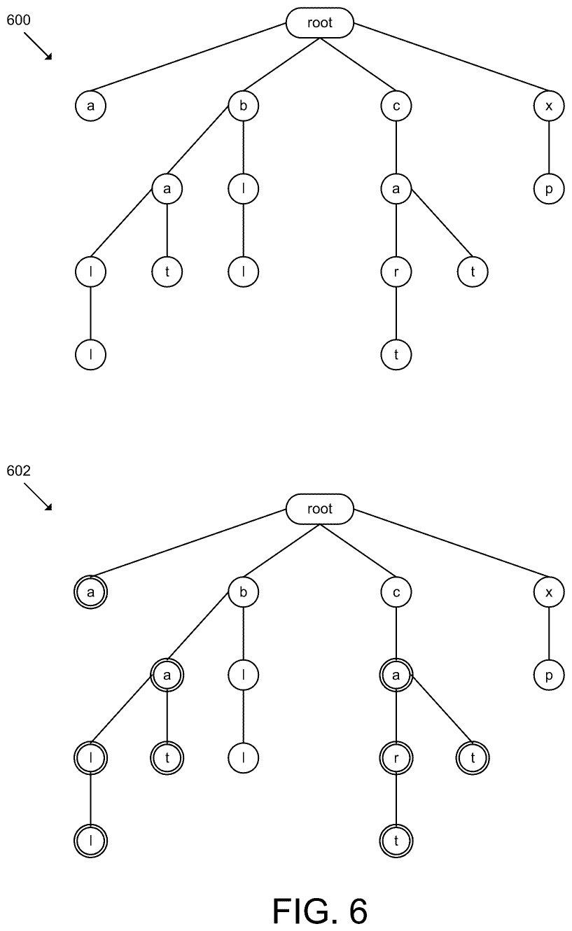

The illustrative method 300 begins with block 302 in which the computing system receives a trie for the entire data set for the organization. For example, as described above, the illustrative technologies may involve the creation of a single “big picture” trie that includes all of the bot flows (e.g., including relative attributes and/or other metadata) for the organization. For simplicity and brevity of the description, this trie may be referred to as a “mother trie” or a “big picture trie.” This mother trie is able to be received by or otherwise accessed by the computing system (e.g., for filtering and querying). FIG. 6 illustrates an example trie in a state 600 in which it has been organized as a “big picture” mother trie (e.g., the state in which the trie is stored). In other embodiments, it should be appreciated that the mother trie may include a plurality of bot flows of the organization, but not necessarily all of the bot flows. For example, a particular organization may have an interest in partitioning its analyses and/or visualizations of bot flows and events.

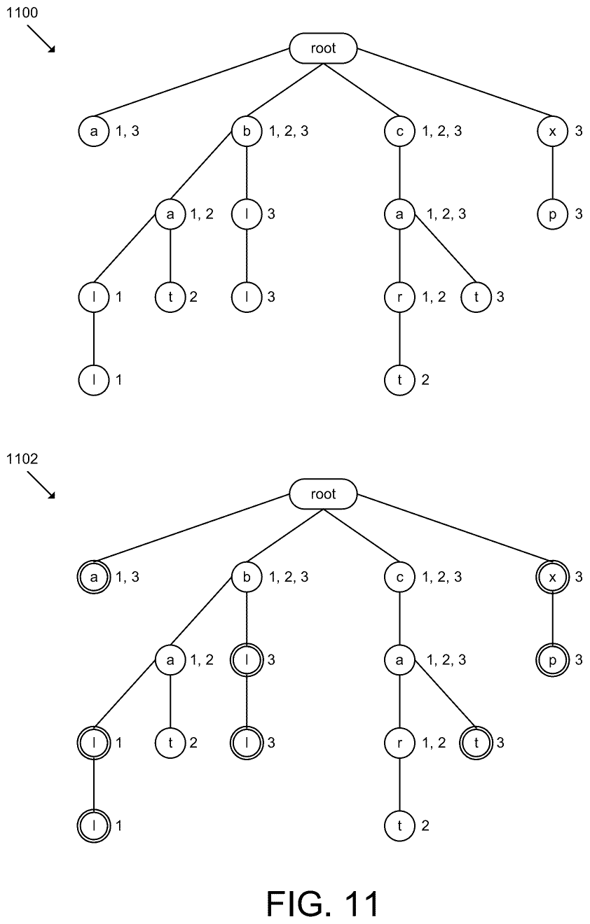

As described above, FIG. 6 illustrates the initial state 600 of an example “big picture” mother trie after it has been created. The illustrative trie is a simple example created for an organization that includes three basic bot flows. For simplicity and clarity of the description, the possible event sequences or “journeys” are described in reference to “words.” A first bot flow includes the journeys BALL (representing a sequence of the events B, A, L, and L), CAR (representing a sequence of the events C, A, and R), and A (representing a sequence including only the event A). A second bot flow includes the journeys BAT (representing a sequence of the events B, A, and T) and CART (representing a sequence of the events C, A, R, and T). A third bot flow includes the journeys CAT (representing a sequence of the events C, A, and T), A (representing a sequence including only the event A), XP (representing a sequence of the events X and P), and BLL (representing a sequence of the events B, L, and L). The same trie is also illustrated in state 1100 of FIG. 11, which further illustrates the bot flow identifiers of the bot flows associated with each event adjacent the corresponding event.

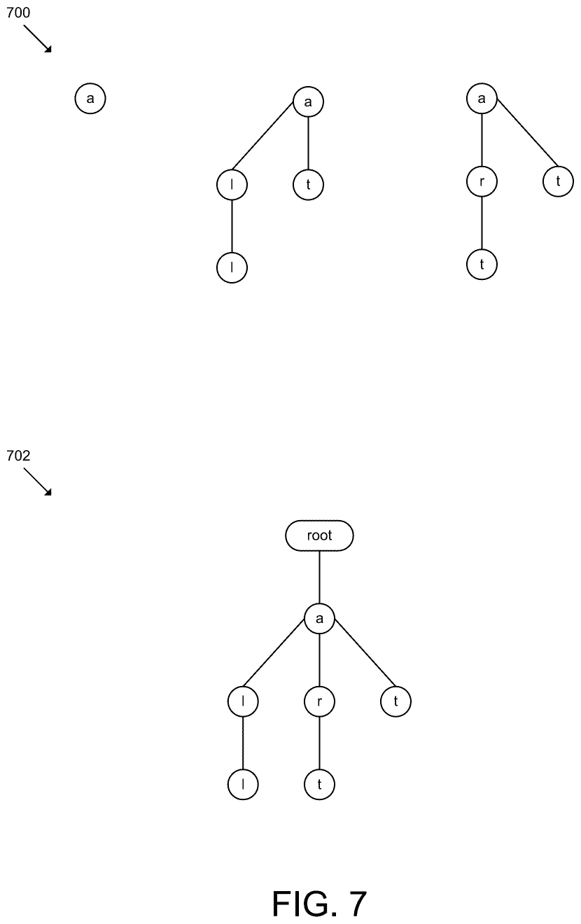

In block 304, the computing system receives a selection of a starting event of the trie by which to filter the trie. For example, as described above, an administrative user may visualize the trie in a graphical user interface and provide user input indicating that the user would like to filter the trie to include only events that include a particular starting event. In the illustrative embodiment of FIGS. 6-7, the user has selected the event “a” to be the starting event. In block 306, the computing system identifies each occurrence of the selected starting event in the trie. For example, as depicted in the state 602 of FIG. 6, the computing system has identified each occurrence of the event “a” in the mother trie, which includes each of the events in the data set as described above. In some embodiments, in block 308, the computing system may perform a depth first search in order to identify each occurrence of the selected starting event in the trie. In other embodiments, the computing system may utilize another search algorithm. In some embodiments, it should be appreciated that, in finding each occurrence of a particular starting event (e.g., the event “a” of the state 602 of FIG. 6), the computing system may also identify each sub-trie that includes the selected event as the starting event (e.g., the three sub-tries highlighted in the state 602 of FIG. 6).

If the computing system determines, in block 310, that one or more occurrences of the selected event have been identified in the trie, the method 300 advances to block 312 in which the computing system extracts the sub-trie associated with each identified starting event. For example, as depicted in the state 700 of FIG. 7, the computing system has extracted three sub-tries from the trie of state 602, each of which sub-trie starts with the selected event “a.” In block 314, the computing system merges the extracted sub-tries to generate an updated trie. For example, as depicted in the state 702 of FIG. 7, the computing system has merged the three illustrative sub-tries of state 700 into a single trie. It should be appreciated that the resultant updated trie satisfies the properties of a trie and, therefore, duplicative journeys are not present, for example. In block 316, the computing system updates the event attributes of the merged and updated trie. For example, if an event in the merged trie was previously present in multiple sub-tries, the counts of the events from the sub-tries may be aggregated, and/or the other attributes may be aggregated or otherwise combined.

In block 318, the computing system provides the updated trie to the administrative user. For example, in some embodiments, the updated trie may be returned to the requesting administrative user device for display on a graphical user interface, for visualization by the administrative user.

Although the blocks 302-318 are described in a relatively serial manner, it should be appreciated that various blocks of the method 300 may be performed in parallel in some embodiments.

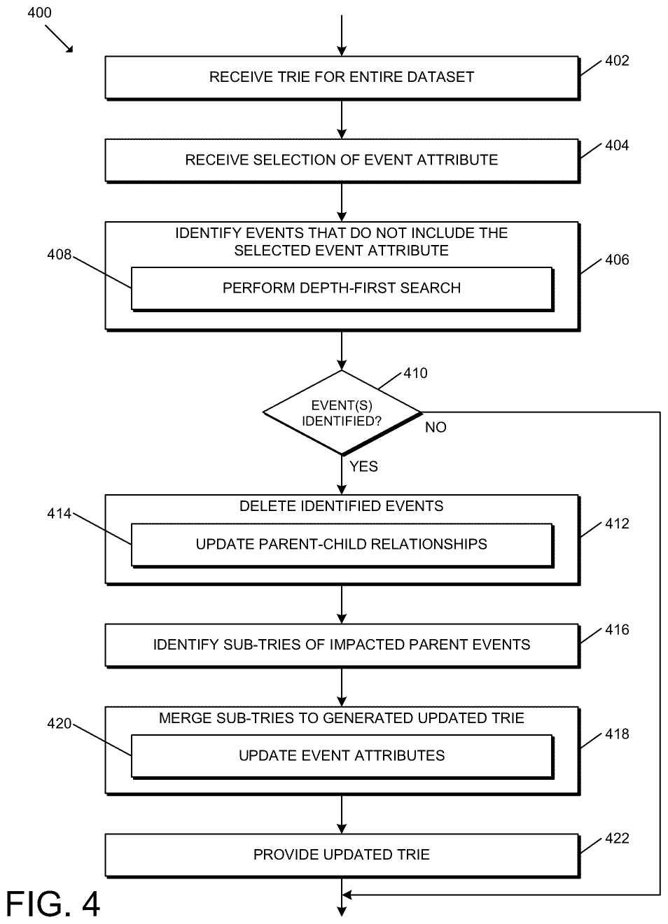

Referring now to FIG. 4, in use, a computing system (e.g., the contact center system 100, one or more computing devices 200, and/or other computing devices described herein) may execute a method 400 for filtering a trie data structure by an event attribute. It should be appreciated that the particular blocks of the method 400 are illustrated by way of example, and such blocks may be combined or divided, added or removed, and/or reordered in whole or in part depending on the particular embodiment, unless stated to the contrary.

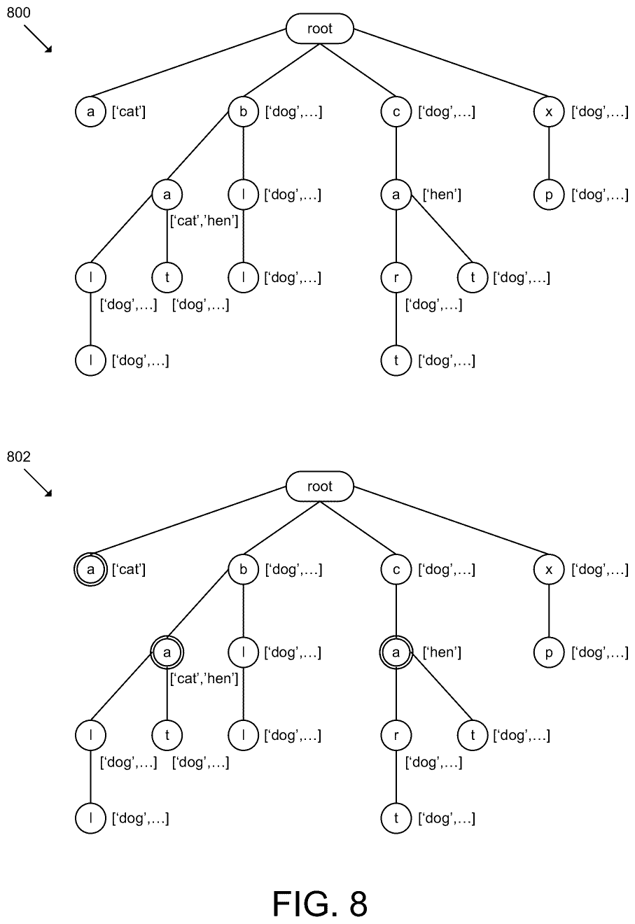

The illustrative method 400 begins with block 402 in which the computing system receives a trie for the entire data set for the organization. For example, as described above, the illustrative technologies may involve the creation of a single “big picture” trie that includes all of the bot flows (e.g., including relative attributes and/or other metadata) for the organization (e.g., a “mother trie”). FIG. 8 illustrates an example trie in a state 800 in which it has been organized as a “big picture” mother trie (e.g., the state in which the trie is stored). The illustrative trie is a simple example created for an organization that includes the three basic bot flows described above. However, in the illustrative embodiment, each of the events includes an “animal” attribute, which includes possible values of at least “dog,” “cat,” and/or “hen.” The attribute values associated with each event are illustrated in FIGS. 8-10 adjacent each corresponding event.

In block 404, the computing system receives a selection of an event attribute of the trie by which to filter the trie or, more specifically, an event attribute value of the trie by which to filter the trie. For example, as described above, an administrative user may visualize the trie in a graphical user interface and provide user input indicating that the user would like to filter the trie to include only events that include a particular selected event attribute value. For example, in the illustrative embodiment of FIGS. 8-10, the user has selected the “animal” attribute and, more specifically, the attribute value of “dog.” In block 406, the computing system identifies each event that does not include the selected event attribute or, more specifically, the selected event attribute value in the trie. For example, as depicted in the state 802 of FIG. 8, the computing system has identified each event/node that does not include the attribute value “dog.” That is, one event was identified as including the attribute value “cat,” one event was identified as including the attribute value [“cat”, “hen”], and another event was identified as including the attribute value “hen.” In some embodiments, the computing system may perform a depth first search in order to identify each event in the trie that does not include the selected event attribute value. In other embodiments, the computing system may utilize another search algorithm.

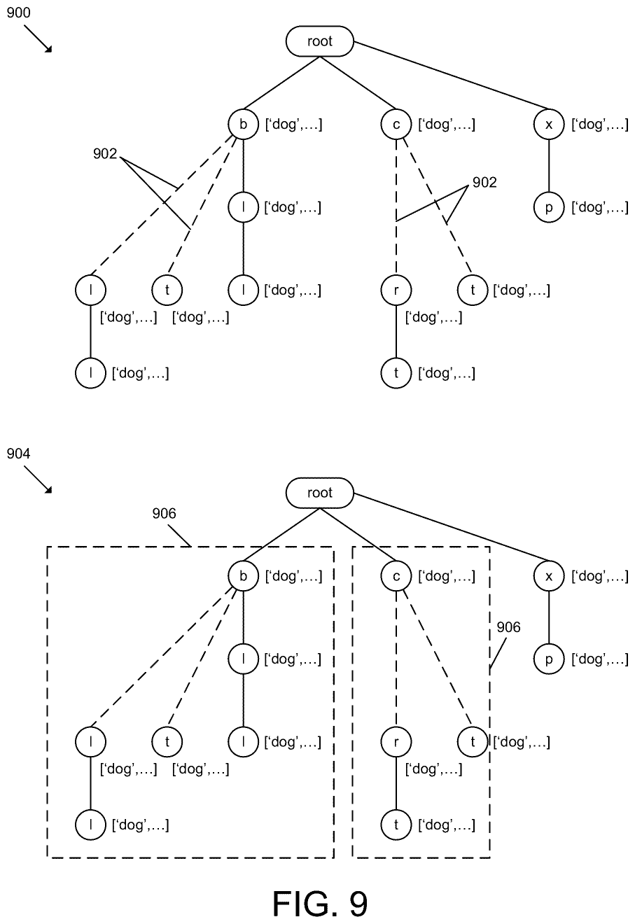

If the computing system determines, in block 410, that one or more events have been identified that does not included the selected event attribute value, the method 400 advances to block 412 in which the computing system deletes the identified events from the trie. In doing so, in block 414, the computing system may update the parent-child relationships impacted by the deletion of the identified events. For example, the prior parent event/node of the deleted event may be temporarily connected (e.g., via a pointer) to the prior child events/nodes of the deleted event. As depicted in the state 900 of FIG. 9, the computing system has deleted each of the identified events and created the temporary connections 902 to update the parent/child relationships impacted by the deletion of the events.

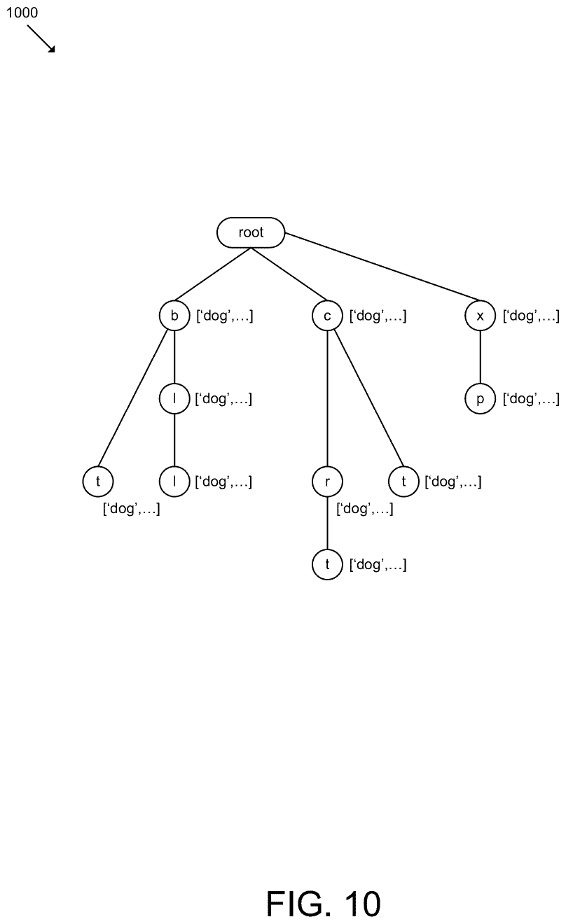

In block 416, the computing system identifies each of the sub-tries of the parent events impacted by the deletion of the events. For example, in some embodiments, each prior parent event/node of a deleted event may be identified as the eldest parent node or root node of a sub-trie. For example, as depicted in the state 904 of FIG. 9, the computing system has identified the sub-tries 906 based on the deleted events. In block 418, the computing system merges the identified sub-tries (e.g., merges the events within each corresponding sub-trie) to generate an updated trie. For example, as depicted in the state 1000 of FIG. 10, the computing system has merged the two illustrative sub-tries 906 of FIG. 9 to create a single trie. As described above, it should be appreciated that the resultant updated trie satisfies the properties of a trie and, therefore, duplicative journeys are not present, for example. In block 420, the computing system updates the event attributes of the merged and updated trie. For example, if an event in the merged trie was previously present in multiple sub-tries, the counts of the events from the sub-tries may be aggregated, and/or the other attributes may be aggregated or otherwise combined.

In block 422, the computing system provides the updated trie to the administrative user. For example, in some embodiments, the updated trie may be returned to the requesting administrative user device for display on a graphical user interface, for visualization by the administrative user.

Although the blocks 402-422 are described in a relatively serial manner, it should be appreciated that various blocks of the method 400 may be performed in parallel in some embodiments.

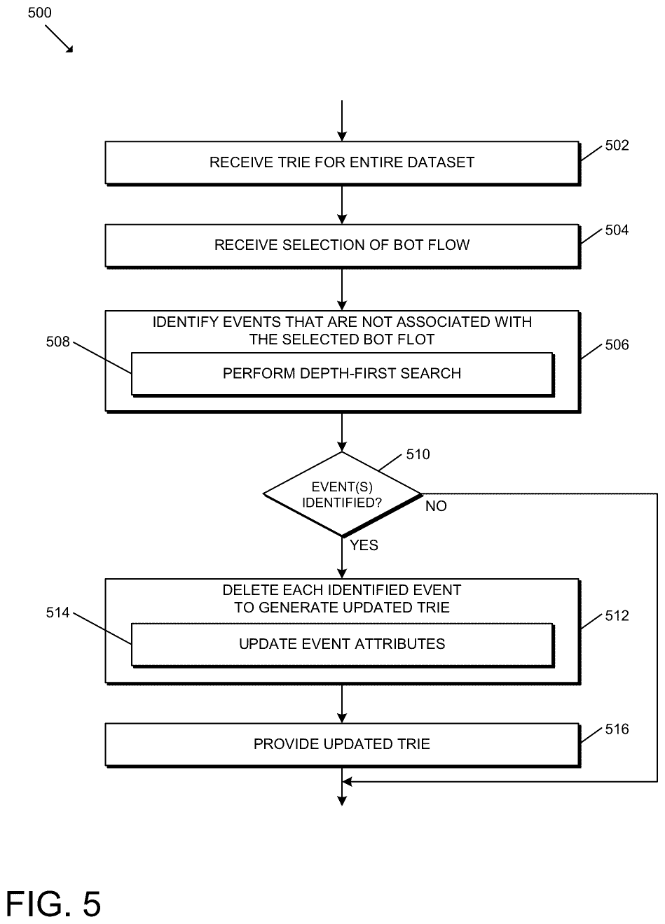

Referring now to FIG. 5, in use, a computing system (e.g., the contact center system 100, one or more computing devices 200, and/or other computing devices described herein) may execute a method 500 for filtering a trie data structure by a bot flow. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system receives a trie for the entire data set for the organization. For example, as described above, the illustrative technologies may involve the creation of a single “big picture” trie that includes all of the bot flows (e.g., including relative attributes and/or other metadata) for the organization (e.g., a “mother” trie). FIG. 11 illustrates an example trie in a state 1100 in which it has been organized as a “big picture” mother trie (e.g., the state in which the trie is stored). As shown in FIG. 11, the state 1100 also illustrates the bot flow identifiers (of bot flow 1, bot flow 2, and bot flow 3) associated with each event adjacent the corresponding event.

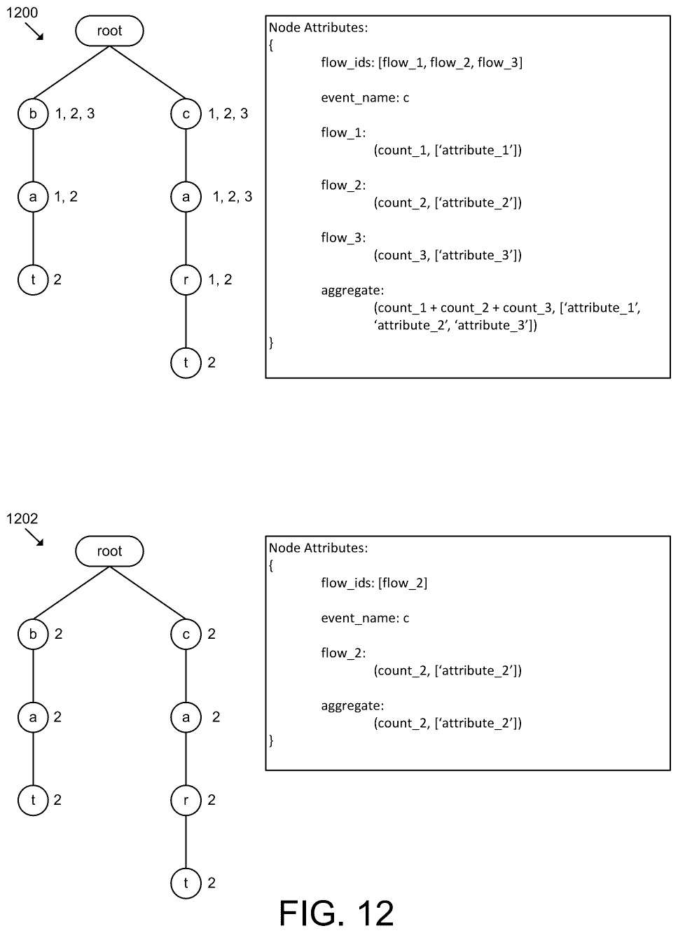

In block 504, the computing system receives a selection of a bot flow of the trie by which to filter the trie. For example, as described above, an administrative user may visualize the trie in a graphical user interface and provide user input indicating that the user would like to filter the trie to include only events that are associated with a particular bot flow. In the illustrative embodiment of FIGS. 11-12, the user has selected to filter the trie to include only events that are from bot flow 2. In block 506, the computing system identifies each event that is not associated with the selected bot flow (e.g., based on associated bot flow identifiers stored as attributes in association with the events). For example, as depicted in the state 1102 of FIG. 11, the computing system has identified each event/node that is not associated with bot flow 2. Those events associated with only bot flow 1 and/or bot flow 3 (and therefore not bot flow 2) have been highlighted for illustrative purposes. In some embodiments, the computing system may perform a depth first search in order to identify each event in the trie that is not associated with the selected bot flow. In other embodiments, the computing system may utilize another search algorithm.

If the computing system determines, in block 510, that one or more events have been identified that are not associated with the selected bot flow, the method 500 advances to block 512 in which the computing system deletes the identified events from the trie. It should be appreciated that if a particular event/node is not associated with a particular bot flow, then none of its children will be associated with that particular bot flow as a matter of inherency. Accordingly, in some embodiments, during a depth first search, the computing system may identify an event/node that is not associated with the selected flow and delete the entire sub-trie of that node without further searching of that sub-trie, which makes the search more efficient. As depicted in the state 1200 of FIG. 12, the computing system has deleted each of the identified events to generate an updated trie. In block 514, the computing system updates the event attributes of the updated trie. It should be appreciated that the deletion of non-selected bot flows may result in the frequency counts changing for events, and attributes may be updated as well as described above. For example, the event/node attributes of the state 1200 reflect the counts and/or other attributes from before deletion of the identified events, whereas the event/node attributes of the state 1202 reflect the updated counts and/or other attributes after deletion of the identified events. Additionally, it should be appreciated that bot flow 2 is the only bot flow identified as being associated with the remaining events.

In block 516, the computing system provides the updated trie to the administrative user. For example, in some embodiments, the updated trie may be returned to the requesting administrative user device for display on a graphical user interface, for visualization by the administrative user.

Although the blocks 502-516 are described in a relatively serial manner, it should be appreciated that various blocks of the method 500 may be performed in parallel in some embodiments.

In addition to the operations filtering, merging, and visualizing trie data structures, a computing system (e.g., the contact center system 100, one or more computing devices 200, and/or other computing devices described herein) may perform operations to enable encoding and decoding of data indicative of a trie data structure in a way that reduces the amount of data to be transmitted between components of the contact center system 100 (e.g. via the network 104) while maintaining the ability to reconstruct the entire trie data structure after transmission. Doing so enables the contact center system 100 to operate faster, by freeing up communication resources that would otherwise be consumed by the transfer of data pertaining to trie data structures, such as in support of operations for filtering, merging, visualizing or otherwise operating on the trie data structures.

Embodiments of the contact center system 100 enable path discovery, which is a type of journey management feature that provides an aggregate view into the most frequently occurring journeys of customers that affect bot containment (i.e., whether a customer escalates from interaction with an automated agent (a bot) to a human agent). Such an escalation may be indicative of a lack of ability of the automated agent to address the needs of the customer and may significantly influence the customer experience. Path discovery may be utilized in other domains relating to journey management that may involve different source datasets and/or the application of different algorithms or data structures. Accordingly, in the illustrative embodiment, flexibility is built into application programming interface (API) contracts associated with the domains. An API contract may be embodied as a technical specification that defines the rules and expectations for how an API should be used, including details such as endpoints, data formats, authentication methods, and the structures of requests and responses between components of a system that utilize the API. In at least some embodiments, path discovery operations do not require configuration and may be executed in a periodic (e.g., nightly) batch process to produce results for one or more organizations associated with the contact center system 100. Accordingly, in at least some embodiments, the contact center system 100 provides a read-only endpoint as the primary API resource. That primary API resource, in at least some embodiments, provides path result sets and filtering capabilities to drill down to specific subsets of paths, such as drilling down from paths across all flows in an organization to paths for one specific flow, in accordance with the operations described herein.

As will be appreciated from the description, a single path represents an aggregated sequence of customer journey events whereas a set of paths represents a collection of aggregated customer journey event sequences. Further, information about paths utilized by the contact center system 100, in the illustrative embodiment, includes counts for each distinct branching path. That is, the count for a given distinct branching path represents the number of times customer(s) followed that particular path. In performing path discovery operations, the contact center system 100 determines paths from a given data set. Further, as used herein, a path domain represents a high-level container to group path discovery use cases. Within a given domain, in the illustrative embodiment, the data structures and algorithms used are consistent. A path category, in the context of the contact center system 100 represents a set of paths that correspond to a specific use case or insight in a given path domain. Structurally, one path domain may contain multiple path categories. A path direction refers to the direction of the paths. Paths are typically unidirectional, in which the direction refers to whether the paths start at a particular event and diverge outwards or whether they converge at a particular end event. A path type, in the context of the contact center system 100, specifies the data structure used to represent the corresponding path.

As will be appreciated, a trie data structure (also referred to herein as a “trie”) is embodied as a tree data structure that aggregates the occurrence of specific unique sequences of nodes. Further, a trie data structure, which may also be referred to as a digital tree or prefix tree in computer science, is used to locate specific keys from within a set. Traditionally, tries are utilized in autocompletion use cases to predict the most likely, by frequency, word based on a given sequence of input characters. That is, in such use cases, each node may represent a character in a word. Referring back to the structure of a trie, the keys may be embodied as strings, with links between nodes defined not by the entire key, but by individual characters. In order to access a key (e.g., to recover the corresponding value, change the value, or remove the value), the trie is traversed depth-first, following the links between nodes that represent each character in the key. Unlike a binary search tree, nodes in the trie do not store their associated key. Rather, a node's position in the trie defines the key with which it is associated. Defining the key of a node based on that node's position in the trie causes the value of each key to be distributed across the trie data structure and means that every node necessarily has an associated value. All of the children of a node have a common prefix of the string associated with the parent node, and the root is associated with an empty string (i.e., the value of the root is an empty string). The task of storing data that can be accessed based on the prefix can be performed in a memory-efficient manner by employing a radix tree. A radix tree is a tree in which each node that is the only child is merged with its parent, thereby causing the number of children of every internal node to be, at most, the radix of the radix tree. Though tries can be keyed by character strings, they need not be. The same algorithms can be adapted for ordered lists of any underlying type, such as permutations of digits or shapes. A bitwise trie, in particular, is keyed on the individual bits making up a piece of fixed-length binary data, such as an integer or memory address. The key lookup complexity of a trie remains proportional to the key size. Specialized trie implementations, such as compressed tries are used to deal with the relatively large space requirement of a trie in naïve implementations.

In the context of path discovery for journey management use cases, for each path, a trie may represent a collection of journey event sequences. Further, a trie, in at least some embodiments, may be constructed from a set of six types of nodes. Each type of node represents important events on a customer journey and has corresponding unique characteristics. A root node is the starting point of the tree and is the only node without a parent node or a parent node identifier. An outcome node, in the illustrative embodiment, represents a flow outcome within a bot flow. The outcome node may be identified using a flowOutcomeId and flowOutcome Value. The flowOutcome Value represents whether the outcome represented by the outcome node was achieved (e.g., success or failure). A milestone node, in the illustrative embodiment, represents a flowMilestone within a bot flow. The milestone node may be identified using a flowMilestoneId and is associated with a flowOutcomeId. An error node may be embodied as a leaf node (i.e., a node with no children) and represents journey(s) that ended with a bot flow error. A transfer node may also be embodied as a leaf node (i.e., a node with no children) and represents the end of a customer journey, in which a customer was ultimately transferred from a bot (an automated agent) to a queue for a human agent. An escalation node may also be embodied as a leaf node and represents one or more journey(s) that ended with a customer expressly requesting (e.g., escalating) a transfer to a human agent queue, such as by stating “Can I speak to an agent?” An exit node may be embodied as a leaf node representing a normal termination of a flow execution.

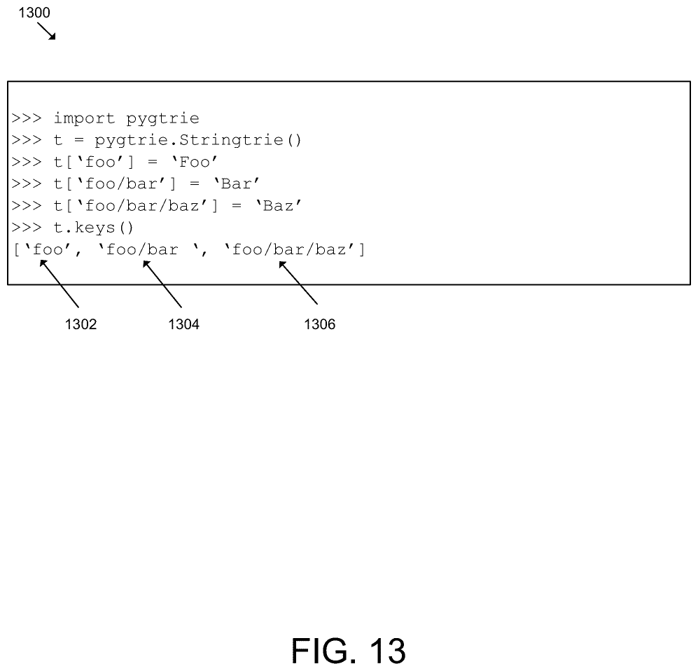

In at least some embodiments, the contact center system 100 may execute a pathfinder process or service that determines paths associated with customer journeys. The pathfinder may also generate bot pathway visualizations. In at least some embodiments, the pathfinder may use a library of trie data structures, such as the pygtrie library adapted for use with the Python programming language, to create and manipulate trie data structures based on one or more data sets. In at least some embodiments, the contact center system 100 may utilize the pygtrie library to facilitate the trie filtering algorithms described above. However, the library utilizes a trie format that is not efficient for the transmission of information about a trie via API responses. As described above, however, communication of trie information between components of the contact center system 100 is necessary to enable customer journey management use cases based on varying data sets and algorithms across different domains, and for transmission of information between back end component(s) and a front end user interface. A significant reason the format, referred to herein as the storage format, utilized by the library is inefficient for transmission of trie data is that in the storage format, each trie node is uniquely represented by the key to that node, which is a path from the root to the node. For example, and referring now to FIG. 13, the code snippet 1300 represents at least some embodiments of the storage format utilized by the library. As shown in the code snippet 1300, the prefix ‘foo’ is repeated for all of the keys 1302.

Storing the entire path to the node provides the benefit of enabling constant order (e.g., a consistent amount of time consumed) extraction of values from a trie. However, while the storage format enables relatively fast data access and manipulation operations when encoded in memory 206, the format relies on the use of redundant information. That is, for example, the storage format encodes the entire path to the node, for each node in the trie data structure. To enable more efficient transmission of data pertaining to trie data structures, such as in API responses, the contact center system 100 may encode the trie data structure in a more succinct format (a transmission format). In the illustrative embodiment, the transmission format encodes only the relevant information to reconstruct the trie and thus, is useful in reducing the size of API responses. Doing so enables the contact center system 100 to utilize trie data structures that include many more nodes (e.g., thousands) than would otherwise be possible without imposing a significant burden on communication resources (e.g., capacity of the network 104).

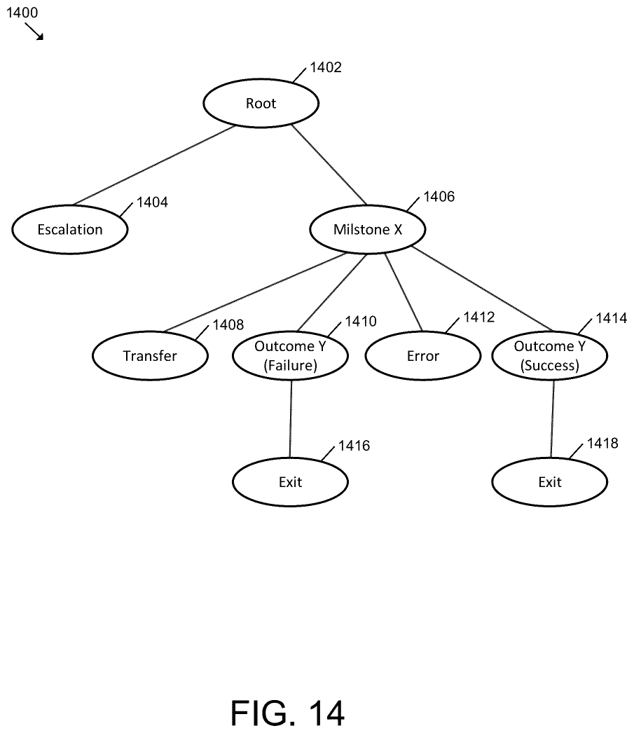

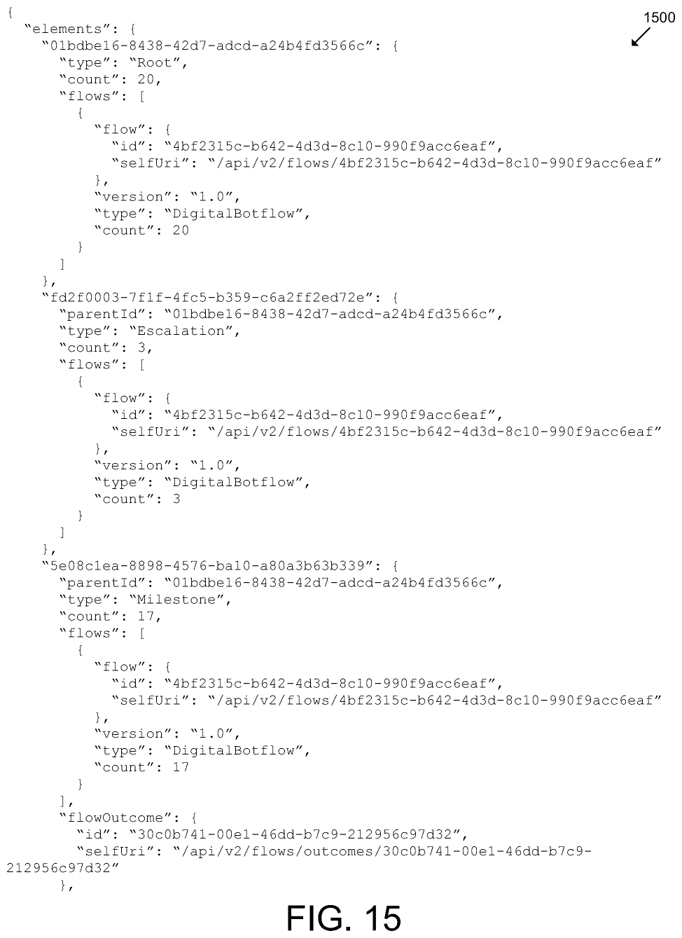

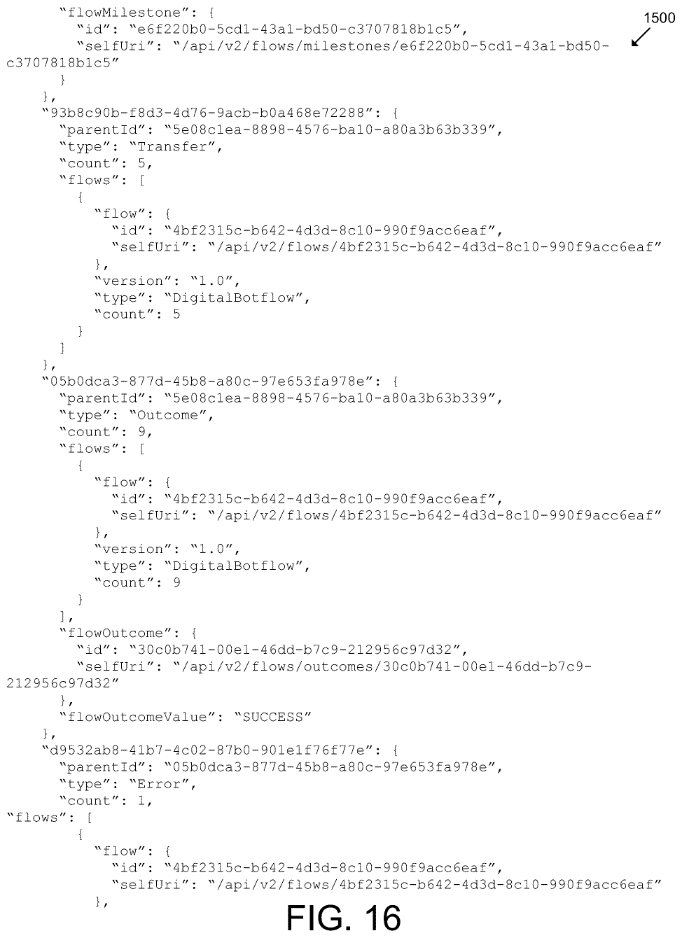

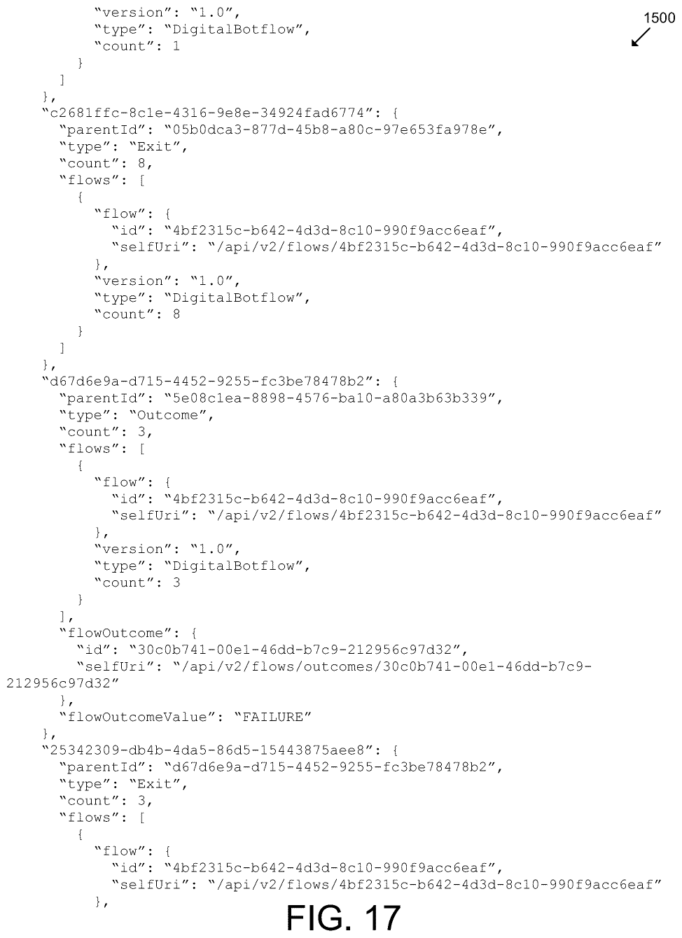

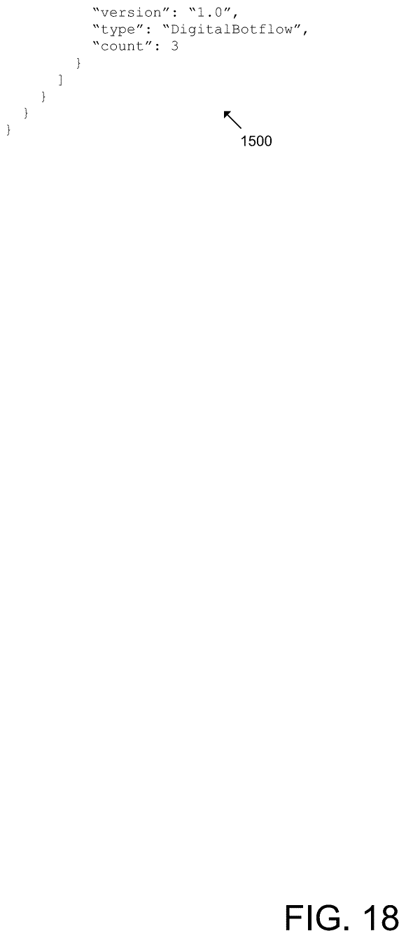

Referring now to FIG. 14, an embodiment of an example trie data structure 1400 that includes nodes 1402, 1404, 1406, 1408, 1410, 1412, 1414, 1416, 1418 associated with customer interactions with automated agents (e.g., bot flows) of the contact center system 100 is shown. The trie data structure 1400 is representative of the following example scenarios. Upon starting the bot flow, three users (e.g., customers) immediately request to speak to a human agent. After reaching milestone X, five users (e.g., customers) are transferred to an agent queue. Of 17 users (e.g., customers) who reached milestone X, three fail to reach outcome Y and nine users (e.g., customers) successfully reached outcome Y. One user (e.g., customer) exited with an error. An example embodiment of an API response 1500 that may be transmitted by the contact center system 100 based on the storage format utilized by the library is represented in FIGS. 15-18.

To enable more efficient transmission of trie data structure information, that would significantly reduce the amount of data transmitted between components of the contact center system 100, the contact center system 100 may produce, from a trie data structure encoded in a storage format, a version of the trie data structure encoded in a transmission format. In doing so, rather than encoding the entire path from the root to a given node, the contact center system 100 encodes only the parent node identifier of that node. Though the amount of data to be transmitted is reduced significantly as a result of the converting the trie data structure to the transmission format, the encoding retains enough information in the transmission format to reconstruct the trie data structure at the receiving end (e.g., by a component that receives a response to an API request pertaining to a tree data structure) back to the storage format, for use by a library, such as the pygtree library discussed above.

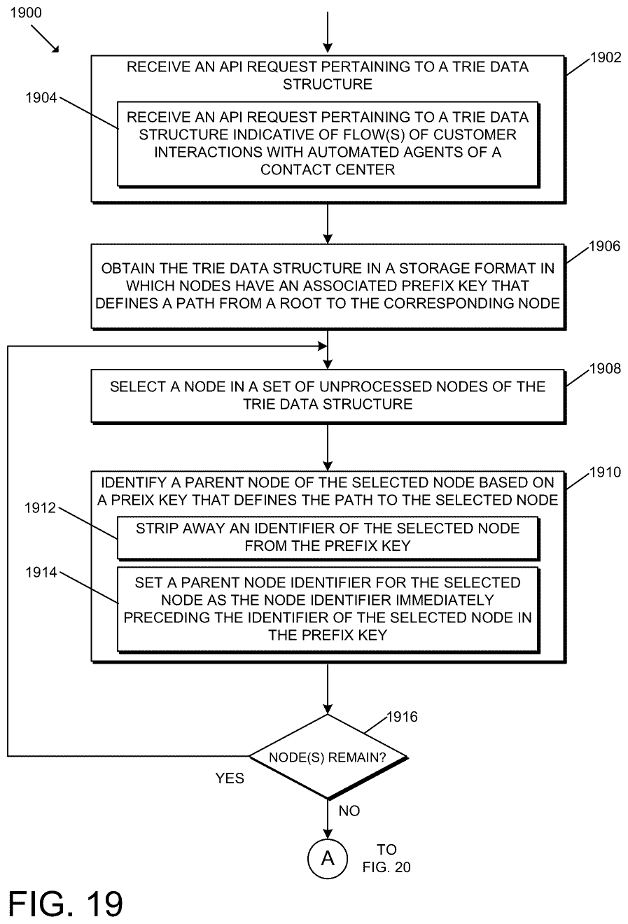

Referring now to FIG. 19, in use, a computing system (e.g., the contact center system 100, one or more computing devices 200, and/or other computing devices described herein) may execute a method 1900 for encoding a trie data structure in a transmission format to enable efficient transmission of data pertaining to the trie data structure. It should be appreciated that the particular blocks of the method 1900 are illustrated by way of example, and such blocks may be combined or divided, added or removed, and/or reordered in whole or in part depending on the particular embodiment, unless stated to the contrary.

The illustrative method 1900 begins with block 1902 in which the computing system receives an API request pertaining to a trie data structure. For example, as described above, a component having access to a trie data structure in memory 206 in the storage format (e.g., for use by the pygtree library) may receive a request from another component of the contact center system 100 that performs operations related to filtering, merging, or visualizing data associated with a trie data structure. In at least some embodiments, as indicated in block 1904, the computing system may receive an API request pertaining specifically to a trie data structure that is indicative of one of more flows of customer interactions (e.g., bot flows) with automated agents (e.g., bots) of a contact center (e.g., the contact center system 100).

Continuing the encoding method 1900, in block 1906, the computing system obtains the trie data structure in a storage format in which nodes have an associated prefix key that defines a path from a root of the trie data structure to the corresponding node. For example, the computing system may read, from memory 206, a trie data structure that is stored in the format utilized by the pygtree library described above, in which a definition of the entire path to a node is stored in association with each node (i.e., as the prefix key) to enable constant order extraction of values of the trie data structure. Continuing the method 1900, the computing system selects a node in a set of unprocessed nodes (e.g., not yet operated on in the encoding process) of the trie data structure that is being encoded into the transmission format. For example, in performing the selection, the computing system may select a leaf node of the trie data structure. In block 1910, the computing system identifies a parent node of the selected node based on the prefix key that defines the path to the selected node. As described above, in the example embodiment, in the storage format, each node has a corresponding prefix key that specifies the entire path from the root to that node. Further, the computing system strips away the identifier of the selected node from the prefix key for that node, in block 1912. As an example, for a selected node, C, that has a prefix key of “ROOT/A/B/C”, the computing system strips away (e.g., deletes) the node identifier, “C”, from the prefix key. As will be appreciated, the node identifier immediately preceding the identifier of the selected node in the prefix key is “B”. In block 1914, the computing system sets, as a parent node identifier (e.g., a property or value of the selected node), the node identifier immediately preceding the identifier of the selected node in the prefix key. Referring again to the example, the computing system sets the parent node identifier to “B” for the selected node, C. The method 1900 continues to block 1916 in which the computing system determines whether other nodes remain in the trie data structure that have not yet been processed. If so, the method 1900 loops back to block 1908 to select another unprocessed node from the trie data structure. The method 1900 continually loops until all nodes of the trie data structure have been processed. As will be appreciated, the root node has no parent. Accordingly, in the illustrative embodiment, the computing system 100 would not perform the operations of block 1910 on the root node, but would still identify the root node as having been processed.

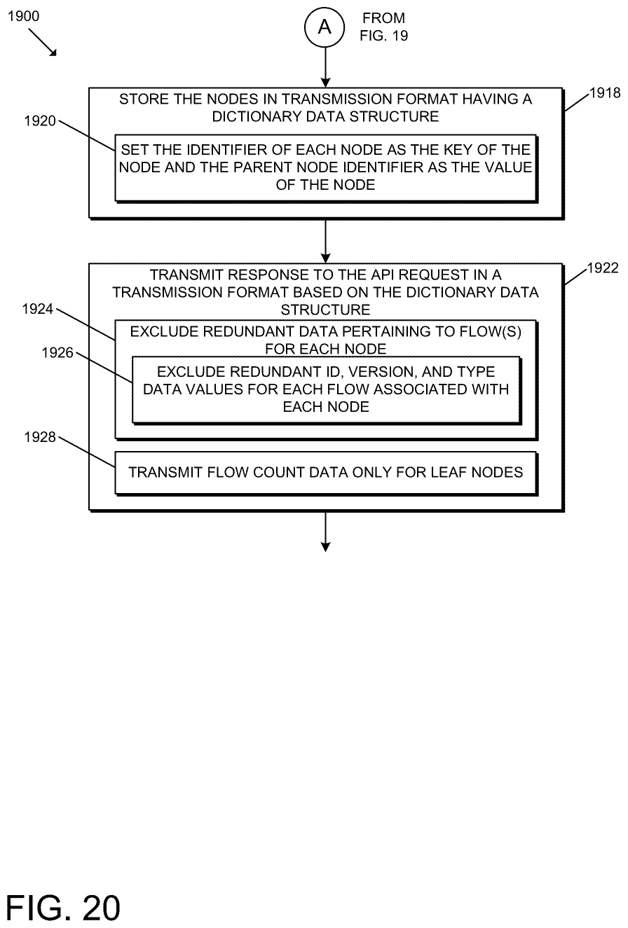

In response to a determination that no nodes remain to be processed, the method 1900 advances to block 1918 of FIG. 20. In block 1918, the computing system stores the nodes in the transmission format, which has a dictionary data structure. A dictionary data structure is a data type in which data is stored as a collection of key-value pairs, in which each unique key is associated with a specific value. As indicated in block 1920, the computing system sets the identifier of each node as the key (the dictionary key) of that node. Further, in the illustrative embodiment, the computing system sets the parent node identifier of the node as the value for that node. The use of a dictionary data structure enables relatively fast (e.g., O(1)) lookups of nodes by their identifier, which is a frequent operation that is employed in a decoding process, described herein.

Continuing the method 1900, the computing system transmits a response to the API request in the transmission format, which as described above, is based on the dictionary data structure, as indicated in block 1922. In doing so, and as indicated in block 1924, the computing system may employ an optimization to further reduce the amount of data transmitted in the response. In particular, the computing system may exclude redundant data pertaining to flows for each node. For example, and as indicated in block 1926, the computing system may exclude redundant identifier, version, and type data values for each flow associated with each node. As another optimization to reduce the amount of data to be transmitted, the computing system, may transmit flow data only for leaf nodes of the trie data structure, as indicated in block 1928.

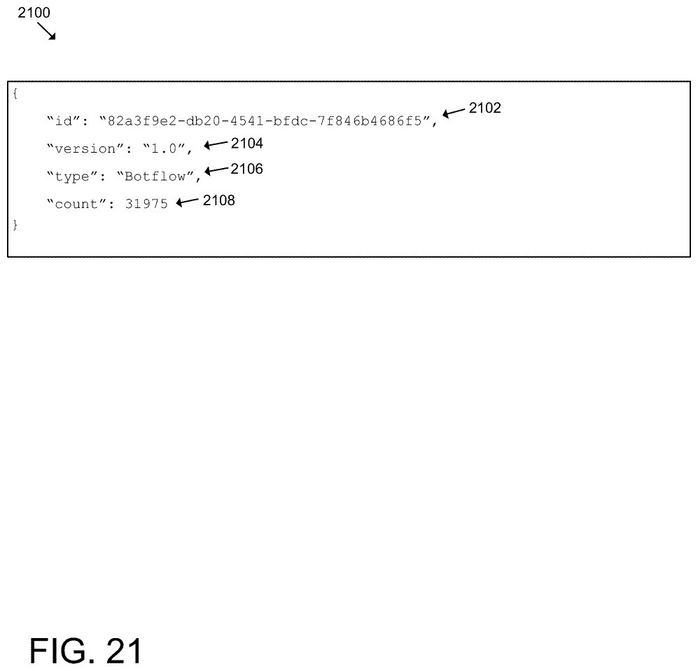

To elaborate on the optimization of blocks 1924, 1926, it is possible for a large unique number of flow identifiers to exist for a given node of a trie data structure. For example, a given node may have 9,000 unique flow identifiers. While transmitting the flow information for a given node with a relatively large number of unique flow identifiers is feasible, as the operations of a contact center expand and additional organizations are represented and/or automated agents are added, transmission of the flow identifiers may become a correspondingly larger burden on the communication resources (e.g., the network 104). Referring now to FIG. 21, an embodiment of an API response 2100 includes an identifier 2102, a version 2104, a type 2106, and a count 2108 regarding each flow at each node. In the operations associated with blocks 1924, 1926, the computing system may reduce the amount of data to be transmitted in the API response by removing redundant information regarding the flows. That is, for example, the identifier 2102, the version 2104, and the type 2106, in at least some embodiments, are repeated for each flow associated with a node and the only data that changes is the count 2108. Accordingly, by excluding the redundant information regarding the flows for each node from the API response, the computing system may significantly reduce the amount of data to be transmitted and thereby reduce the burden that may otherwise be imposed on the network 104.

Regarding the operation of block 1928, transmitting only flow count data for leaf nodes of the trie data structure (e.g., by setting flows ==[ ] for non-leaf nodes) also reduces the amount of data in the API response without impacting the ability to recreate the information in a decoding process. That is, the count for a flow at each node is the sum of the counts of the children nodes. Accordingly, by only retaining and transmitting information for leaf nodes (e.g., terminal nodes of the trie data structure that do not have children), the computing system can determine the counts of the flows for the rest of the nodes (e.g., the non-leaf nodes). Although the blocks 1902-1928 are described in a relatively serial manner, it should be appreciated that various blocks of the method 1900 may be performed in parallel in some embodiments.

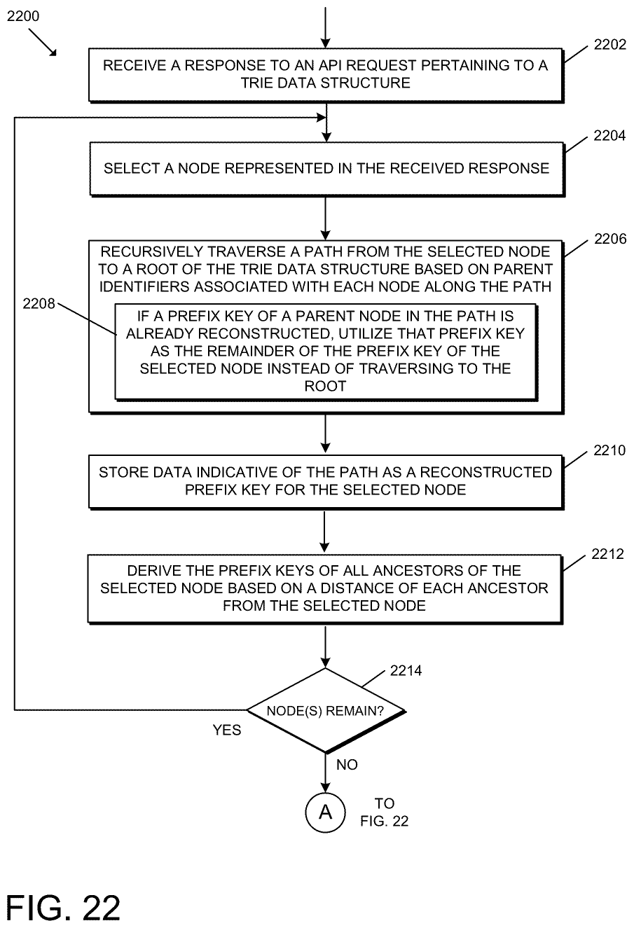

Referring now to FIG. 22, in use, a computing system (e.g., the contact center system 100, one or more computing devices 200, and/or other computing devices described herein) may execute a method 2200 for decoding a trie data structure from a transmission format to support the efficient communication of data pertaining to the trie data structure. It should be appreciated that the particular blocks of the method 2200 are illustrated by way of example, and such blocks may be combined or divided, added or removed, and/or reordered in whole or in part depending on the particular embodiment, unless stated to the contrary.

The illustrative method 2200 begins with block 2202 in which the computing system receives a response to an API request that pertains to a trie data structure. For example, a component of the contact center system 100 may receive a response from another component of the contact center system 100 in the transmission format described relative to the encoding method 1900. Continuing the method 2200, the computing system selects a node represented in the received response, as indicated in block 2204. Having selected a node, the computing system recursively traverses a path from the selected node to a root of the trie data structure based on the parent node identifier associated with each node along the path, in block 2206. That is, as described above with reference to the encoding method 1900, any given node, with the exception of the root node, has a value (e.g., a “parentId”) that identifies the parent node of that node. Accordingly, the computing system may traverse from any given node to its parent, then to the parent of that parent, and so on, until the root node is reached. By doing so, the computing system reconstructs the path from the node to the root. As described above, in the target format (e.g., the storage format) for the trie data structure, a prefix key that specifies the entire path from the root to the node is stored in association with the corresponding node. In at least some embodiments, the computing system may perform an optimization in block 2208 in which, if the computing system encounters a parent node for which the prefix key (the path) has already been reconstructed, the computing system utilizes that prefix key as the remainder of the prefix key (the path) for the selected node, rather than traversing the rest of the path to the root. That is, the prefix key of that parent node already specifies all of the remaining nodes along the path to the root and, as such, can be adopted as the remaining portion of the prefix key for the selected node. As will be appreciated, performing optimization associated with block 2208 reduces the number of traversals required to reconstruct the prefix key for the nodes of the trie data structure, and in turn, reduces the processing resources that may otherwise be required to perform the decoding process. In block 2210, having determined the path from the selected node to the root, the computing system stores the path as the reconstructed prefix key for the selected node.

In some embodiments, the computing system may perform an optimization in block 2212. That is, in some embodiments, the computing system may derive (e.g., determine) the prefix keys of all ancestors of the selected node based on a distance of each ancestor from the selected node. That is, referring back the example above in which the prefix key for a selected node, C, is “ROOT/A/B/C”, the computing system may determine that the prefix key for the parent node, B, is “ROOT/A/B” by stripping away one node identifier based on the fact that the parent node B has a distance of one from the selected node, C. Further, for the parent node, A, which is the parent of parent node, B, the computing system may strip away two node identifiers from “ROOT/A/B/C” to obtain the prefix key “ROOT/A” for parent node A. By following such a scheme, the computing system may eliminate the number of node traversals and correspondingly reduce the amount of processing resources (e.g., time) that may otherwise be required to convert the encoding of the trie data structure from the transmission format to the storage format. In block 2214, the computing system determines whether any unprocessed nodes remain. If so, the method 2200 loops back to block 2204 to select another node to be processed as described above.

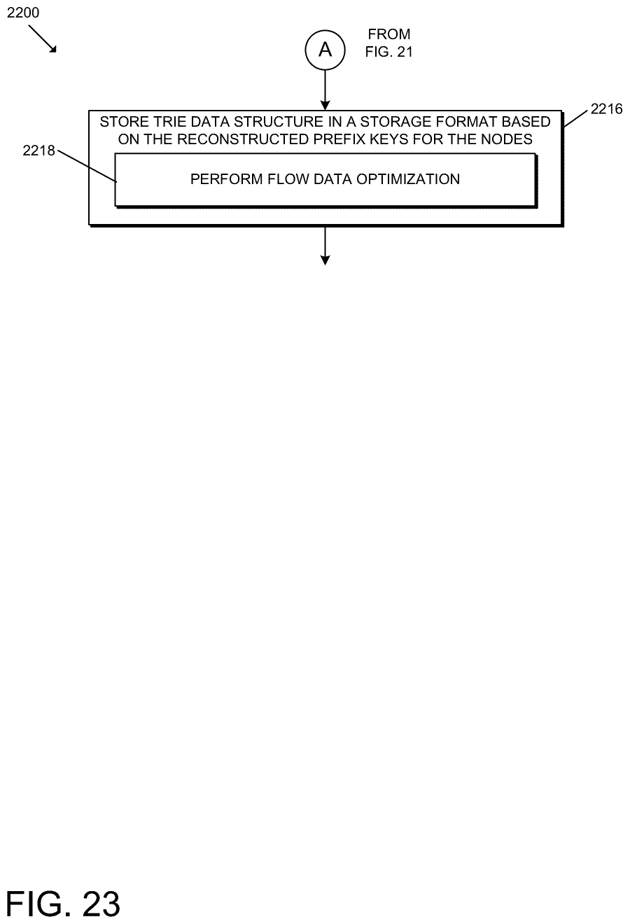

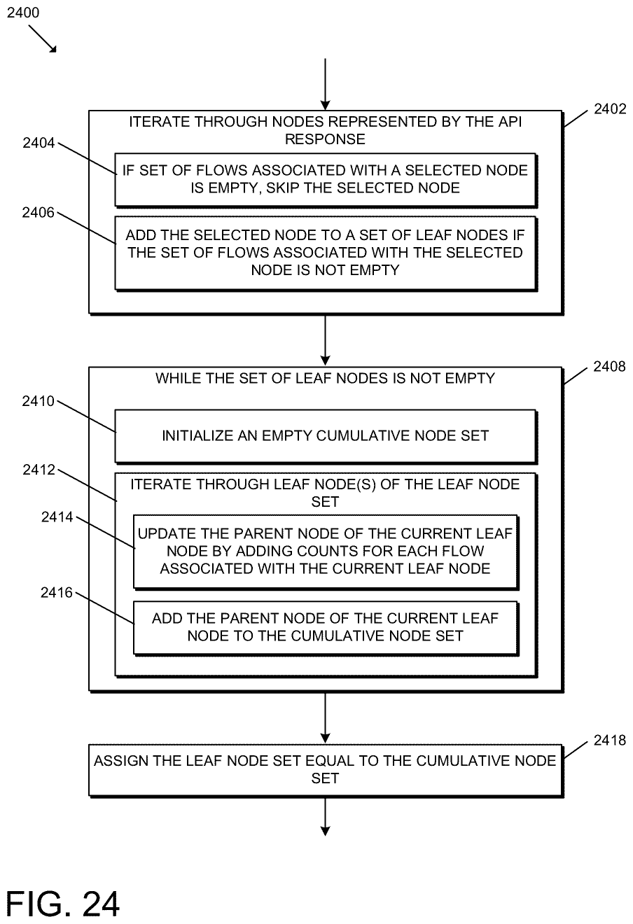

In response to a determination in block 2214 that no unprocessed nodes remain, the method 2200 advances to block 2216 of FIG. 23, in which the computing system stores the trie data structure (e.g., in the memory 206) in a storage format based on the reconstructed prefix keys for the nodes. That is, the computing system stores the trie data structure in a format in which each node includes a prefix key that specifies the entire path from the root to the corresponding node. As described above, utilizing such a storage format enables relatively fast, constant order extraction of values from the trie data structure. In embodiments in which the received response includes flow data only for the leaf nodes, the computing system may perform a corresponding flow data optimization process in block 2218 to reconstruct the flow data for the non-leaf nodes. Although the blocks 2202-2218 are described in a relatively serial manner, it should be appreciated that various blocks of the method 2200 may be performed in parallel in some embodiments. An embodiment of a method 2400 for reconstructing the flow data for non-leaf nodes is described relative to FIG. 24.

Referring now to FIG. 24, in use, a computing system (e.g., the contact center system 100, one or more computing devices 200, and/or other computing devices described herein) may execute a method 2400 for reconstructing flow data from a transmission format to support the efficient communication of data pertaining to the trie data structure. It should be appreciated that the particular blocks of the method 2400 are illustrated by way of example, and such blocks may be combined or divided, added or removed, and/or reordered in whole or in part depending on the particular embodiment, unless stated to the contrary.

The illustrative method 2400 begins with block 2402 in which the computing system iterates through nodes represented by an API response, such as the response received in block 2202 of the decoding method 2200. While iterating through the nodes, the computing system performs operations as a function of whether a selected node (e.g., corresponding to a given iteration) has an empty set for its flow data. That is, in block 2404, in response to a determination that the set of flows associated with the selected node is empty, the computing system skips the selected node (e.g., selects another node). However, in response to a determination that the set of flows associated with the selected node is not empty, the computing system adds the selected node to a set of leaf nodes in block 2406. Referring back to block 1928 of the encoding method 1900, the optimization involves transmitting flow count data only for the leaf nodes. Accordingly, if a selected node has flow data that is not empty, the computing system determines that the selected node must be a leaf node and adds the selected to a set of leaf nodes.

Continuing the method 2400, the computing system, in block 2410 performs a set of operations while the set of leaf nodes, produced in block 2402, is not empty. In doing so, the computing system initiates an empty set of nodes, referred to herein as a cumulative node set. In block 2412, the computing system iterates through the leaf nodes in the set of leaf nodes produced in block 2402. For each iteration, in block 2414, the computing system updates the parent node of the current leaf node associated with the present iteration, by adding counts for each flow associated the current leaf node. That is, the computing system determines the parent of the current leaf node (e.g., based on the parent node identifier or the prefix key reconstructed in the decoding method 2200) and adds, to any flow data associated with that parent node, the flow count data for the current leaf node. Further, in block 2416, the computing system adds the parent node of the current leaf node to the cumulative node set. In block 2418, the computing system assigns the leaf node set equal the cumulative node set that was initialized and populated in in the operations of block 2408. Although the blocks 2402-2418 are described in a relatively serial manner, it should be appreciated that various blocks of the method 2400 may be performed in parallel in some embodiments.

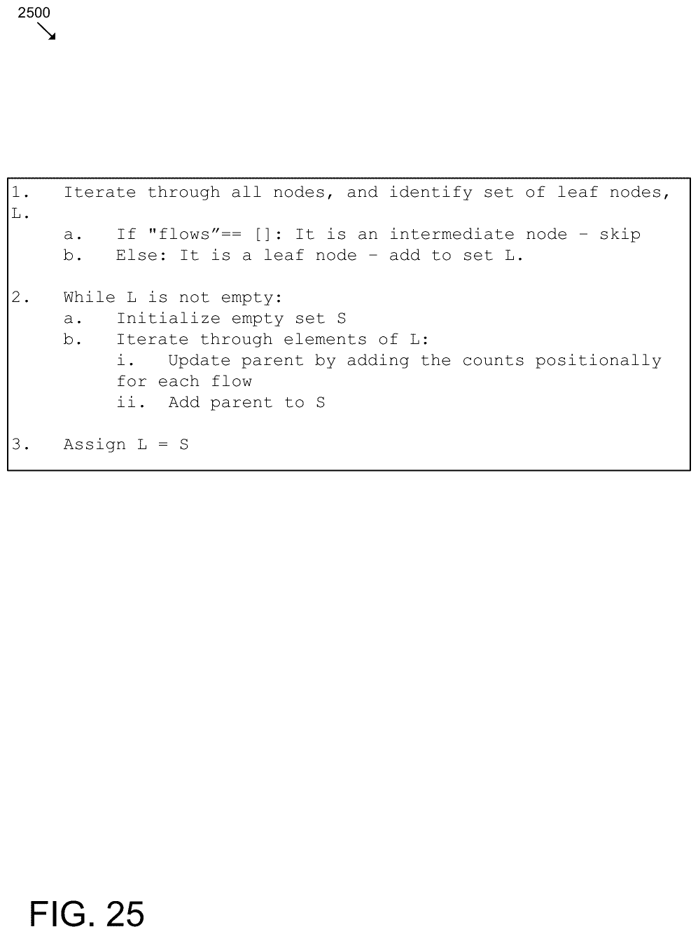

Referring briefly to FIG. 25, a pseudo code snippet 2500 represents the operations of the method 2400. In the snippet 2500, the “flows” variable represents a list, which inherently maintains order. Accordingly, adding counts positionally updates all flow counts correspondingly. The algorithm described above, in the illustrative embodiment, has a time complexity of O(F*T), in which F represents the number of flows and T represents the number of nodes in the trie data structure.

1. A method for efficiently encoding a trie data structure for transmission, the method comprising:
receiving, by a computing system, an application programming interface (API) request pertaining to the trie data structure, wherein the trie data structure is indicative of flows of customer interactions with automated agents of a contact center;
obtaining, by the computing system, the trie data structure in which each node of multiple nodes of the trie data structure has an associated prefix key that defines a path from a root to the corresponding node;
encoding, by the computing system, the nodes of the trie data structure in a transmission format having a dictionary data structure, in which an identifier of each node is defined as a key of the corresponding node and a parent node identifier for each node is defined as a value of the corresponding node, wherein the nodes in the transmission format do not have the prefix key that defines the path from the root to the corresponding node; and
transmitting, by the computing system, a response to the API request based on the trie data structure encoded in the transmission format.

2. The method of claim 1, wherein encoding the nodes of the trie data structure in the transmission format comprises:
stripping away an identifier of each node from the prefix key of the corresponding node; and
setting the parent node identifier for the corresponding node as a node identifier immediately preceding the identifier of the corresponding node in the prefix key.

3. The method of claim 1, wherein transmitting the response to the API request comprises excluding, from the response, redundant data pertaining to flows for each node.

4. The method of claim 3, wherein excluding redundant data comprises excluding, from the response, redundant identifier, version, and type data values for each flow associated with each node.

5. The method of claim 1, wherein transmitting the response to the API request comprises transmitting flow count data only for leaf nodes represented in the trie data structure.

6. The method of claim 1, further comprising:
receiving, by the computing system, the response to the API request pertaining to the trie data structure;
reconstructing, by the computing system, the prefix keys for nodes of the trie data structure based on parent node identifier data associated with each node;
storing, by the computing system, the trie data structure in a storage format based on the reconstructed prefix keys for the nodes.

7. The method of claim 1, wherein reconstructing the prefix keys comprises, for each node of a set of nodes represented in the response, (a) selecting, by the computing system, a node represented in the received response, (b) recursively traversing, by the computing system, a path from the selected node to a root of the trie data structure based on a parent node identifier associated with each node along the path to the root, and (c) storing, by the computing system, data indicative of the path as the prefix key for the selected node.

8. The method of claim 7, further comprising deriving, by the computing system, the prefix key of all ancestors of the selected node based on a distance of each ancestor from the selected node.

9. The method of claim 7, further comprising:
determining, by the computing system, whether a prefix key of a parent node of the selected node has already been reconstructed; and
utilizing, by computing system and in response to a determination that the prefix key of the parent node has already been reconstructed, the prefix key of the parent node as a remainder of the prefix key for the selected node.

10. (canceled)

10. A system for efficiently encoding a trie data structure for transmission, the system comprising:
at least one processor; and
at least one memory comprising a plurality of instructions stored thereon that, in response to execution by the at least one processor, causes the system to:
receive an application programming interface (API) request pertaining to the trie data structure, wherein the trie data structure is indicative of flows of customer interactions with automated agents of a contact center;
obtain the trie data structure in which each node of multiple nodes of the trie data structure has an associated prefix key that defines a path from a root to the corresponding node;
encode the nodes of the trie data structure in a transmission format having a dictionary data structure, in which an identifier of each node is defined as a key of the corresponding node and a parent node identifier for each node is defined as a value of the corresponding node, wherein the nodes in the transmission format do not have the prefix key that defines the path from the root to the corresponding node; and
transmit a response to the API request based on the trie data structure encoded in the transmission format.

11. The system of claim 10, wherein to encode the nodes of the trie data structure in the transmission format comprises to:
strip away an identifier of each node from the prefix key of the corresponding node; and
set the parent node identifier for the corresponding node as a node identifier immediately preceding the identifier of the corresponding node in the prefix key.

12. The system of claim 10, wherein to transmit the response to the API request comprises to exclude, from the response, redundant data pertaining to flows for each node.

13. The system of claim 12, wherein to exclude redundant data comprises to exclude, from the response, redundant identifier, version, and type data values for each flow associated with each node.

14. The system of claim 10, wherein to transmit the response to the API request comprises to transmit flow count data only for leaf nodes represented in the trie data structure.

15. The system of claim 10, wherein the plurality of instructions further causes the system to:
receive the response to the API request pertaining to the trie data structure;
reconstruct the prefix keys for nodes of the trie data structure based on parent node identifier data associated with each node; and
store the trie data structure in a storage format based on the reconstructed prefix keys for the nodes.

16. The system of claim 10, wherein to reconstruct the prefix keys comprises, for each node of a set of nodes represented in the response, to (a) select a node represented in the received response, (b) recursively traverse a path from the selected node to a root of the trie data structure based on a parent node identifier associated with each node along the path to the root, and (c) store data indicative of the path as the prefix key for the selected node.

17. The system of claim 16, wherein the plurality of instructions further causes the system to derive the prefix key of all ancestors of the selected node based on a distance of each ancestor from the selected node.

18. The system of claim 16, wherein the plurality of instructions further causes the system to:
determine whether a prefix key of a parent node of the selected node has already been reconstructed; and
utilize, in response to a determination that the prefix key of the parent node has already been reconstructed, the prefix key of the parent node as a remainder of the prefix key for the selected node.

19. One or more non-transitory machine-readable storage media comprising a plurality of instructions stored thereon that, in response to execution by a computing system, causes the computing system to:
receive an application programming interface (API) request pertaining to the trie data structure, wherein the trie data structure is indicative of flows of customer interactions with automated agents of a contact center;
obtain the trie data structure in which each node of multiple nodes of the trie data structure has an associated prefix key that defines a path from a root to the corresponding node;
encode the nodes of the trie data structure in a transmission format having a dictionary data structure, in which an identifier of each node is defined as a key of the corresponding node and a parent node identifier for each node is defined as a value of the corresponding node, wherein the nodes in the transmission format do not have the prefix key that defines the path from the root to the corresponding node; and
transmit a response to the API request based on the trie data structure encoded in the transmission format.

20. The one or more non-transitory machine-readable storage media of claim 19, wherein to encode the nodes of the trie data structure in the transmission format comprises to:
strip away an identifier of each node from the prefix key of the corresponding node; and
set the parent node identifier for the corresponding node as a node identifier immediately preceding the identifier of the corresponding node in the prefix key.
